(19) United States
(12) Patent Application Publication
(10) Pub. No.: US 2006/0000515 A1
(43) Pub. Date: Jan. 5, 2006

(54) Dredge flotation hose and system

(76) Inventor: Thomas R. Huffman, Minnetrista, MN (US)

Correspondence Address: Craig F. Taylor;Fredrikson & Byron, P.A., 4000 Pillsbury Center, 200 South Sixth Street, Minneapolis, MN, 55402-1425, US

(21) Appl. No.: 10/883,863

(22) Filed: Jul. 2, 2004

(51) Int. Cl. F16L 11/00

(52) U.S. Cl. 138/114

(57) ABSTRACT

Devices, methods, and systems for providing portable dredging flotation hoses capable of being wound on reels in a reduced volume configuration and transported to dredging sites. Some dredge flotation hoses include a first lay-flat hose disposed about a second, inner lay-flat hose and sealed at both ends of the first lay-flat hose to form an inflatable annular space therebetween. Some devices have a coupling member at either end of the lay-flat hoses to receive and couple the inner lay-flat hose within the outer lay-flat hose and provide external access to the channel flowing through the inner lay-flat hose. A closeable orifice can be provided through the body of the coupling device to allow inflation of the annular volume between the inner and outer lay-flat hoses. Lay-flat hose pairs having sizes of 3 and 4 inches to 10 and 12 inches, and other combinations are provided by the present invention. Composite lay-flat hoses can be transported on a reel to a large manure lagoon, unwound, inflated, floated between the lagoon edge and a dredging unit, and used to transport a manure-water slurry to conventional hoses, then spread upon fields near the manure lagoon. The composite flotation hose can then be deflated, wound onto the reel, and transported to the next lagoon to be serviced. The simple inflation and deflation, winding and unwinding, is significantly easier than transporting, assembling and disassembling conventional flotation pipe segments.

### FIELD OF THE INVENTION

The present invention is related generally to dredging equipment. More specifically, the present invention is related to flotation hoses that can be used in dredging and manure lagoon emptying operations.

### BACKGROUND OF THE INVENTION

Hoses pipes are sometimes used to transport liquids, slurries, or other liquid-solid mixtures across a liquid body. The hose or pipe may therefore be required to float on the liquid surface. Flotation hoses or pipes are used in dredging and also in crude oil transport to and from some tankers.

In oil transport, it appears to the applicant that large flotation hoses or pipes are allowed to float on the surface of water between an on-shore facility and a buoy, or between a buoy and an offshore tanker. High volumes of oil may be pumped through the hose over the water.

In dredging operations, a floating barge, often on pontoons, is positioned on water, over a region to be deepened. An auger can be brought to bear on the sea or lake floor and used to stir up the bottom into a slurry. The slurry can be pumped up to the barge with a first pump, and pumped to shore through a flotation hose. The barge is usually moved over the body of water to be deepened, with the hose moved as well. When the dredging operation is complete, the hose can be rolled up and transported to another site.

Modern farming techniques often rely on efficiency of scale for survival and profitability. In one example, animal raising and feeding is often done at a central facility having a large number of animals. Chickens, turkeys, pigs, and cows are often housed at a large facility, with the resulting generation of large quantities of manure. This manure is collected and stored. The manure storage pit may be quite large in some instances. Some storage pits or lagoons are about 800 feet long, 250 feet wide, about 20 feet deep, and can hold about 30 million gallons of manure.

The manure may ultimately be spread onto a field for two reasons. First, to dispose of the manure, and second, to apply fertilizer to the field. The manure is often applied only in the spring and fall in some regions. The manure is often not spread when it either will not be absorbed or cannot be applied because of the presence of crops. The manure is thus held for a long time period of several months.

At appropriate times, the manure is spread on the fields. While it is possible for a single farm to invest in the specialized equipment, and to use this equipment only twice a year, this is often not done. Instead, service providers buy the equipment and travel from site to site, pumping out the manure lagoons onto the fields.

This is often done by positioning a floating barge or dredge on the lagoon surface, and coupling the moving barge to the lagoon edge using a floated hose or pipe of some sort. Sometimes the hose or pipe empties into a storage tank. In other systems, the same hose or pipe, or a different hose or pipe, can continue from the lagoon to a tractor carrying a manure spreader or sprayer. The tractor can travel back and forth over the fields, with the hose trailing behind, spreading the manure on the fields. The hose length may be on the order of a mile. So-called “lay-flat” hose is currently used. Lay-flat hose lays flat when not pressurized, rather than remain round. Lay-flat hose is similar in some respects to fire hose carried on fire trucks. The lay-flat house can be wound on a large reel and transported to a site, followed by unrolling the reel. This compaction allows storing one or two lengths of 660-foot lay-flat hose on a single hose reel.

The portion of the hose or pipe in the lagoon is floated on the surface of the liquid. This is currently done in different ways, all of them relatively awkward. In one system, a pontoon roughly the diameter of the hose is positioned on either side of the hose or pipe sections with a cradle or sling between to support the hose or pipe. Several lengths of these double pontoons may be slid under the hose in the lagoon to support the hose. In another system, large diameter sections of hose or pipe having a foam jacket are coupled to the lay-flat hose to provide floating hose or pipe sections.

The current methods are fairly awkward to set up, tear down, and transport. The transport of these systems may occur every day of so. For this reason, the floating hose or pipe sections can create a substantial amount of work in order to pump out each lagoon.

What would be desirable is a device for providing flotation hose without having to add and remove flotation devices at every lagoon.

### SUMMARY OF THE INVENTION

The present invention includes a first lay-flat hose sealed at each end and coupled along its length to a second lay-flat hose. The first lay-flat hose can serve as the inflatable flotation hose and be coupled to the second hose, which can be used to transfer pumped liquid or solid-liquid mixture. The present can include a first lay-flat hose sealingly secured about a second, smaller diameter lay-flat hose to form a flotation space between the two hoses. Air can be introduced between the two hoses to float the composite, double walled hose. The seal can be accomplished using an air-tight fitting, coupling, adhesive, or bond. Some hoses have a coupling at either end having the two hoses secured to external annular grooves with compression rings. At least one coupling may have a closeable orifice within for admitting and expelling air between the floatation space and the outside of the hose and coupling.

The present invention also includes a flotation hose comprising a first lay-flat hose having a first region and a second region longitudinally displaced from the first region. The flotation hose further includes a second lay-flat hose disposed within the first lay-flat hose, having a first region and a second region displaced longitudinally from the first region. The flotation hose can further include a first seal for sealing the first lay-flat hose first region to the second lay-flat hose first region and a second seal for sealing the first lay-flat hose second region to the second lay-flat hose second region. A sealed annular volume can be formed between the first lay-flat hose and the second lay-flat hose and be used to receive a flotation gas to float the flotation hose.

In some flotation hoses, the first and second seals are formed of a rigid material and have the hoses held against the seals with compression rings. Some flotation hoses also include a valve providing externally closeable gas access to the annular volume within. In some hoses, the valve is disposed in at least one of the first and second seals. In other hoses, the valve is disposed through the wall of the first lay-flat hose. The seal can be formed from various metals, polymers, ceramics, sealants, adhesives, and bonding methods well known to those skilled in the art.

In some flotation hoses, the first lay-flat hose has an outside diameter when fully pressurized that is at least about 10 times the height of the first lay-flat hose when the hose is empty and not pressurized. Some hoses are fiber reinforced. In various embodiments, the first lay-flat hose has an outside diameter that is at least about 3, 4, 5, 6, 8, 10, or 12 inches when inflated. Some flotation hoses according to the present invention have a length of at least about 100 feet.

The present invention also includes a system for conveying fluids including a first lay-flat hose having a second lay-flat hose disposed within, the first lay-flat hose having a seal at either end to seal the first lay-flat hose to the second lay-flat hose and to form a space therebetween. The system can include a hose reel having the first and second lay-flat hoses wound there about. The hoses can have a closeable orifice for allowing entry and exit of a gas into the space between the first and second hoses. The closeable orifice is disposed within the seal in some embodiments and through the wall of one of the hoses in another embodiment. The first lay-flat hose can have an outside diameter when fully pressurized that is at least about 10 times the height of the lay-flat hose when empty and not pressurized. The same relative dimensions can be true for the second lay-flat hose as well.

A method for making a flotation hose is also included within the present invention. The method can include disposing a second lay-flat hose inside a first lay-flat hose and coupling the first and second lay-flat hoses together at two longitudinally distant regions of the first lay-flat hose to form a space between the first and second hoses. The space can be pressurized with a gas to fill the annular volume between the first and second hoses. The method can include filling the space with the gas to float the flotation hose thus made. The method may include providing a device having an orifice to provide gas access to the annular space between the first and second hoses from outside of the first hose.

A method for removing water and solids from a body containing water and solids to at least an edge of the body is also provided by the present invention. This method can include unrolling a composite hose from a reel, where the reel includes a first lay-flat hose sealingly disposed about a second lay-flat hose. A gas can be introduced into the space formed between the first and second hoses. One end of the composite hose can be coupled to a moveable solid-liquid mixing or dredging device. The hose can be extended between the moveable solid-liquid mixing or dredging device and the edge of the body, such that the composite hose having the gas within floats on the body.

In some methods, the method further includes pumping the solid-liquid mixture from the moveable device to the edge of the body. The body may include manure and the pumping may include pumping a manure-water mixture. Some methods include pumping a fresh water-sediment mixture from a body including fresh water and sediment. Methods can include operation on a body including salt water and sediment, wherein the pumping includes pumping a salt water-sediment mixture. Brackish water and sediment may also be operated upon, by pumping a brackish water-sediment mixture. Industrial sludge and wastewater sludge can also be pumped using the present invention.

The invention can also include a coupling device for creating a flotation hose from a first lay-flat hose and a second lay-flat hose, where the second lay-flat hose has a smaller outside diameter than the first lay-flat hose. The coupling device can include a body having a first region for coupling to the first hose, a second region for coupling to the second hose, and a third region for receiving or discharging a fluid, and a lumen there through. The second region can have an outside diameter about equal to the inside diameter of the second hose while the first region can have an outside diameter about equal to the inside diameter of the first hose. The coupling device can be used such that the first hose is coupled to and about the first region with a first compression ring, and the second hose is coupled to and about the second region with a second compression ring.

In some devices, the second region is disposed longitudinally between the first and second regions. Some coupling devices have the first region disposed longitudinally between the second and third regions. In various such coupling devices, the second region has an outer diameter of at least about 3 inches while the first region has an outer diameter of at least about 4 inches. In various embodiments, the second and first regions have nominal outer diameters of 3 and 4 inches respectively, 4 and 6 inches respectively, 6 and 8 inches respectively, 8 and 10 inches respectively, and 10 and 12 inches respectively. Some devices include at least one external groove in the first, second, or third regions for receiving a portion of the respective hose driven inward by a compression member. Some coupling devices provide an orifice through the body to provide external gas access to a flotation space between the first and second hoses.

### DESCRIPTION OF THE DRAWINGS

FIG. 1A is a side, perspective view of a prior art dredge including pontoons, a submerged auger/tiller cutterhead and a slurry pump;

FIG. 1B is a front view of the dredge of FIG. 1A, better illustrating the cutterhead;

FIG. 2A is a side view of a prior art flotation pipe section including an aluminum pipe, an aluminum float, and attached electrical cables;

FIG. 2B is a side view of a prior art flotation pipe section including an aluminum pipe having a foam float thereabout;

FIG. 2C is a side view of a prior art flotation pipe section having a polyethylene pipe within a foam flotation float;

FIG. 3A is a top view of two prior art float pipes connected by a strap to hold a pipe section in between;

FIG. 3B is an end view of the two float pipes and carried pipe section of FIG. 3A;

FIG. 4 is a top view of a manure lagoon having a floating pumping or dredging unit coupled to shore with prior art flotation pipe sections coupled together;

FIG. 5 is a fragmentary, cutaway view of a flotation hose according to the present invention, having one lay-flat hose disposed within another lay-flat hose, coupled together with fittings and segments to form an annular flotation lumen therebetween;

FIG. 6 is a side view of a coupling from FIG. 5 having a region for coupling to an inner lay-flat hose and a larger outer diameter region for coupling to a second lay-flat hose as well as an orifice for allowing passage of flotation gas in between the first and second hoses;

FIG. 7 is a fragmentary side, perspective view of a coupling similar to that of FIG. 6, having an inner hose and outer hose (not shown in FIG. 7) and a threaded internal region at right;

FIG. 8 is a perspective view of the coupling of FIG. 6, including the orifice for enabling passage of flotation gas;

FIG. 9 is a perspective view of a hose reel for carrying lay-flat flotation hoses and other lay-flat hoses;

FIG. 10A is a fragmentary, longitudinal, cross-sectional view of an alternate embodiment of the invention having the two hoses sealed by an inner ring, which resists the compressive force of an outer ring;

FIG. 10B is a transverse, cross-sectional view of the device of FIG. 10A;

FIG. 11 is a fragmentary, longitudinal, cross-sectional view of an alternate embodiment having the outer lay-flat hose sealed at opposite ends to the inner lay-flat hose using sealant and having the inflation orifice in the outer lay-flat hose; and

FIG. 12 is a transverse, cross-sectional view of an upper lay-flat hose filled with air coupled to a lower lay-flat hose.

### DETAILED DESCRIPTION OF THE PREFERRED EMBODIMENTS

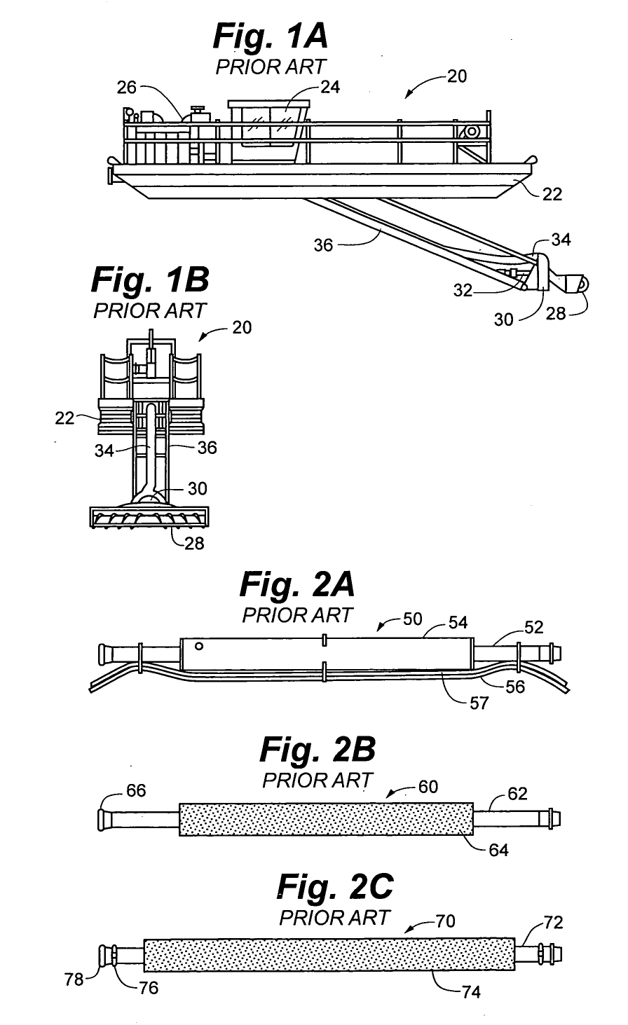

FIG. 1A illustrates a floating dredge 20 which is used with prior art systems and can be used with the present invention. Dredge 20 includes pontoons 22, operator cab 24, diesel engine 26, and ladder 36. Submerged ladder 36 carries at the end an auger/tiller cutterhead 28 which then convert the manure or sediment and water into a slurry mixture, which then can be pumped by submerged pump 30 through hose 34 up ladder 36 and to a coupling to further pump the slurry to shore. A drive shaft or hydraulic coupling 32 may be used to supply pump 30 for power for pumping the slurry up to the surface and, in some systems, further on to shore. Dredges are available from SRS Crisafulli, Inc. (Glendive Mont., USA).

FIG. 1B illustrates dredge 20 from the front, better illustrating auger/tiller cutterhead 28 and pump 30. Dredge 20 can include motorized winches for pulling the dredge back and forth on prepositioned winch cables to completely traverse the channel to be deepened or the manure lagoon to be emptied.

FIG. 2A illustrates a prior art flotation pipe section 50 including an inner aluminum pipe 52 for transferring the mixture or fluid, surrounded by an aluminum flotation pipe 54. Pipe 52 may be about 40 feet long. Flotation pipe 50 includes pump electrical cables 56 and 57 attached to the float and pipe. Flotation pipe 54 may be from 10 to 20 feet, or longer, in some systems. Flotation pipe section 50 may be coupled to other sections or to flexible sections not having flotation devices attached.

FIG. 2B illustrates another prior art flotation pipe section 60 having an inner aluminum pipe 62 for transferring a mixture or a slurry and an outer foam flotation jacket 64. Flotation pipe 60 is terminated at one end by a gasket 66 for coupling to other pipes.

FIG. 2C illustrates yet another prior art flotation pipe section currently in use, flotation pipe 70, having an inner polyethylene pipe 72 surrounded by an outer foam jacket or pipe 74. A gasket 78 and a band 76 for attaching the gasket may be seen in FIG. 2C.

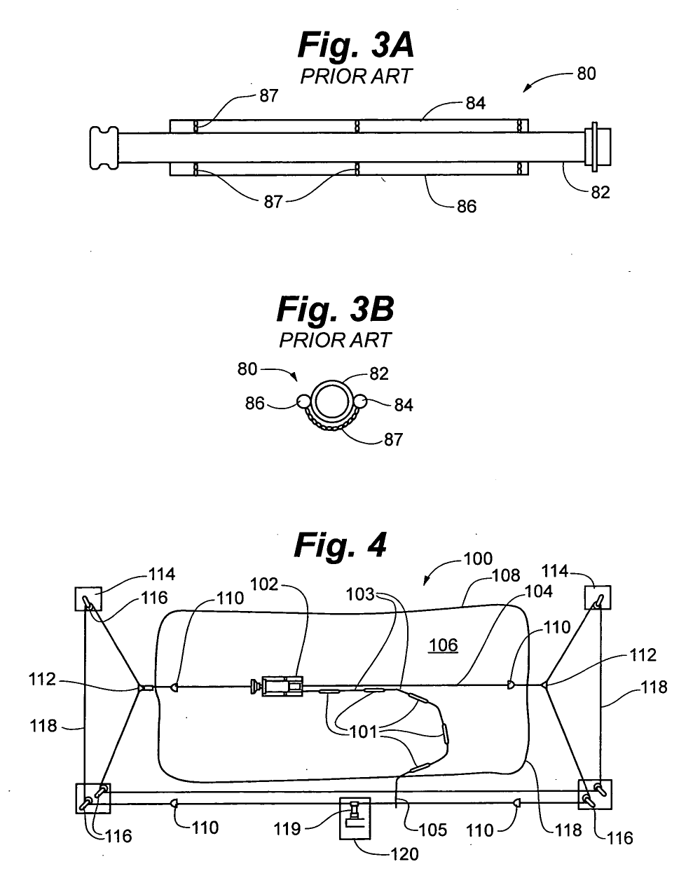

FIG. 3A illustrates still another prior art flotation pipe section currently in use. Flotation pipe 80 includes a pipe 82 for transporting a fluid or slurry carried between a first flotation pipe 84 and a second flotation pipe 86 which are connected together under pipe 82 by straps 87. Flotation pipes are available from SRS Crisafulli, Inc. (Glendive, Mont., USA).

FIG. 3B illustrates an end view of flotation pipe 80, better illustrating strap 87 carrying pipe 82 between the two flotation pipes 86 and 84.

The prior art flotation pipes of FIGS. 2A, 2B, 2C, 3A, and 3B may be seen to be rather cumbersome. In particular, none of these devices lend themselves to being around a hose reel and transported easily to site. Furthermore, these sections must obviously be coupled to other sections to achieve any length, typically requiring significant manual labor to join these sections end to end to achieve any useful length of flotation pipe. These nominally 20 to 40 foot sections must also be put on some sort of trailer and transported from site to site, removed, assembled into useful lengths, floated onto the liquid surface, and later removed, disassembled, loaded onto a trailer, and transported to another site.

FIG. 4 illustrates a manure lagoon 100, used with a series of prior art flotation pipe sections 101 joined end to end as indicated at 103. Flotation pipe sections 101 can carry the mixture or liquid to shore, to a section of nonflotation pipes at region 105. Lagoon 100 includes generally a liquid or mixture portion 106 and shore or berm region 108. The lagoon may be about 800 feet long, 250 feet wide, 20 feet deep, and hold about 30 million gallons of manure.

Floating dredging unit 102 may be seen carried on traversing cable 104 between the cable stops 110. Traversing cable 104 is coupled to a grip hoist cable tensioner 112 that is coupled to other cables 118 attached to stationary corner sheaves 116 coupled to concrete piers 114. This cable system can be controlled by a lateral positioning capstan winch 119 controlled by a controller or control panel 120. Lagoon 100 may thus be emptied or at least partially emptied of manure by floating dredging unit 102 traversing back and forth over various length sections of lagoon 100, and pumping the generated slurry through flotation pipe sections 101 to nonfloating pipe 105 on shore region 108. A flotation hose according to the present invention, described next, can be used in place of flotation pipe sections 101 of FIG. 4.

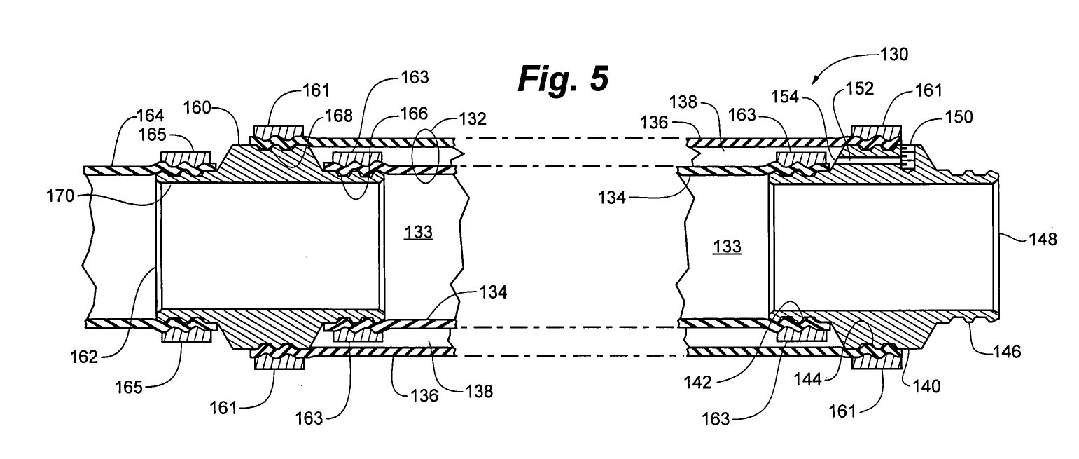

FIG. 5 illustrates a lay-flat flotation hose system 130 according to the present invention. Lay-flat flotation hose system 130 includes a composite lay-flat hose 132 including an inner lay-flat hose 134 and an outer lay-flat hose 136 having a space or annular lumen 138 formed therebetween. Lumen 138, as is discussed below, can serve as a flotation lumen. System 130 also includes a first seal, fitting, or coupling 140 and a second seal, fitting, or coupling 160. First coupling 140 includes a lumen 148 there through for receiving or discharging fluid from a major flow lumen 133 with an inner hose 134. First seal 140 also includes a first region 142 for coupling inner hose 134 to seal 140 and a second region 144 for coupling second hose 136 to seal 140. Coupling regions 142 and 144 may use any standard coupling system, well known to those skilled in the art. Regions 142 and 144 can include annular grooves for coupling the lay-flat hoses to seal 140 using hose clamps, segments, locking rings, or other compression devices well known to those skilled in the art. Seal 140 also includes a third region 146 that can be used to couple a third hose to seal 140. In some systems, third region 146 has about the same outer diameter as first region 142 and can have the same size hose coupled there over. Segments 161, 163, and 165 are used in this embodiment to secure hoses 134, 136, and 164 to seals 140 and 160.

Seal 140 may also be seen to have an orifice 154 in communication with annular space 138. Orifice 154 is coupled through a channel 152 to another orifice 150 that can be in communication with the outside atmosphere. In some systems, orifice 150 is a half-inch I.D., pipe threaded opening, which can receive a threaded plug, a threaded ball valve, or any other suitable device.

Second seal 160 may be seen to include a first coupling region 166, a second coupling region 168 and a third coupling region 170. In the example illustrated, seal 160 has no orifice for inflating the composite lay-flat hose system. Another hose 164 may be seen coupled to second seal 160 at coupling region 170. Hose 164 may be used to receive fluid from, or discharge fluid into, hose lumen 133 through second seal lumen or channel 162.

In use, hose system 130 can be carried to site, and one end coupled to the desired terminus, e.g. a floating dredge. The hose can be further unwound from the reel until the opposite end, for example, first seal 140 is accessible. A compressor can be coupled to threaded orifice 150 and used to inflate the annular space 138 with any inflation gas or flotation air, to about 1-2 PSIG. When the composite hose has been sufficiently filled with air or other gas, threaded orifice 150 can be shut, using a plug or a ball valve. Hose system 130 can be coupled at first seal 140 to still another, nonfloating hose, and system 130 dragged onto the surface of the fluid body to be dredged or emptied. In some methods, hose system 130 can be dragged into the body of fluid simultaneously with, or after, being filled with flotation gas.

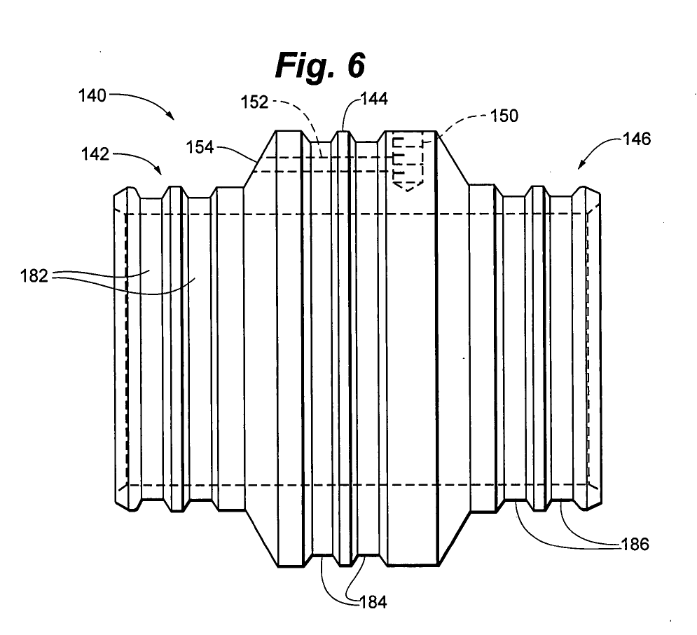

FIG. 6 illustrates first seal or coupling 140 of FIG. 5 in greater detail. First coupling region 142, second coupling region 144, and third coupling region 146 may be seen, as previously described. Orifice 154, channel 152 and external orifice or threaded orifice 150 may be seen, also as previously described. Coupling 140 may be seen in first region 142 to include annular external grooves 182. Grooves 182 can be used to receive locking segment 163 disposed over the lay-flat hose to couple the lay-flat hose to first region 142. Similarly, second region 144 may be seen to have annular grooves 184 for receiving the outer lay-flat hose and the outer locking segment 161 or hose clamps to secure the outer lay-flat hose to the coupling. Third region 146 may be seen to also include annular grooves 186 for receiving the locking members 165 to lock the lay-flat hose to the coupling. In some systems, coupling 140 is used to receive rather large diameter lay-flat hoses. In one system, first region 142 and second region 144 are dimensioned to receive three and four inch hoses, respectively, in other systems, these regions are dimensioned to receive four and five inch hoses respectively, six and eight inch hoses respectively, eight and ten inch hoses respectively, and ten and twelve inch hoses respectively.

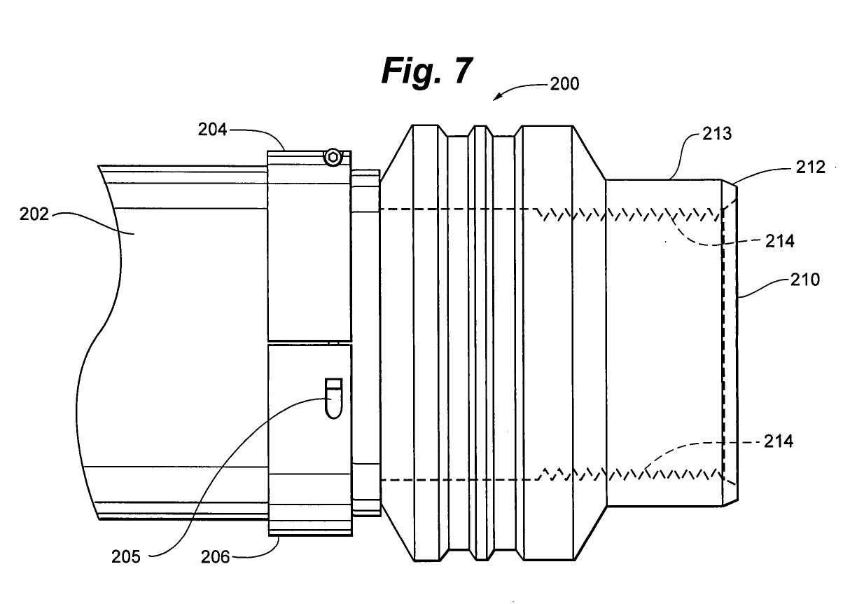

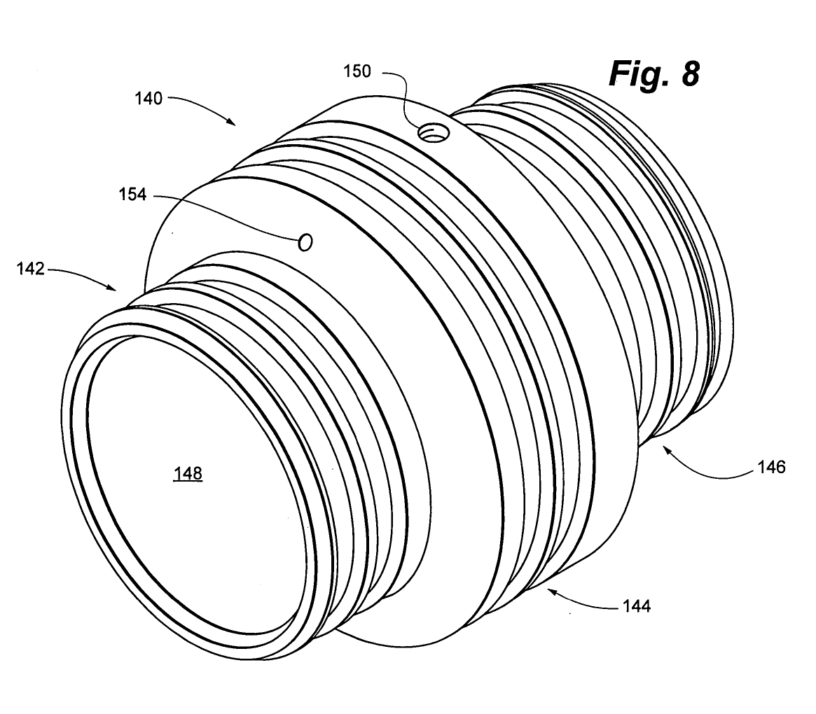

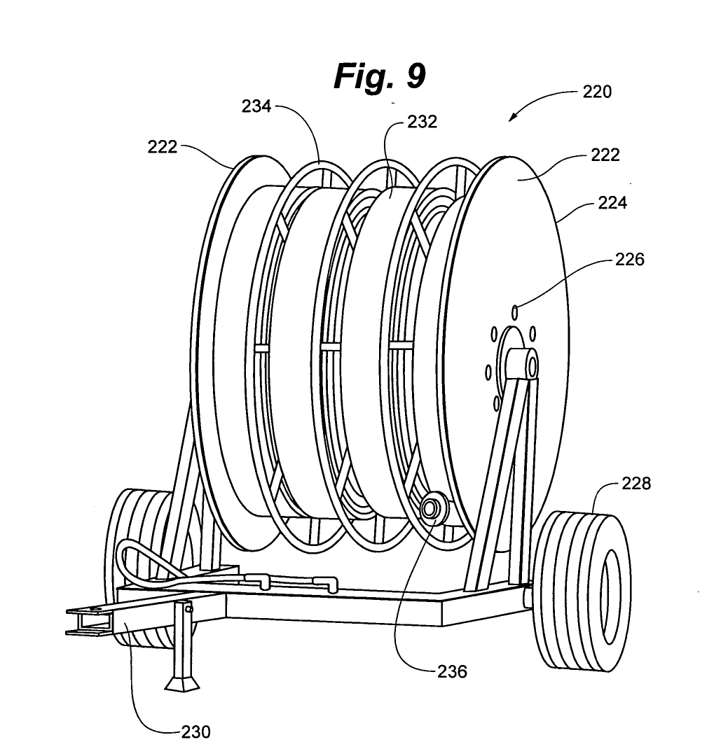

FIG. 7 illustrates another seal or a coupling device 200, similar in many respects to the coupling devices previously described. An inner lay-flat hose 202 may be seen coupled to coupling device 200, by a first segment 204 coupled to a second segment 206 with a bolt 205. In some embodiments, the segments may be partially received within underlying annular grooves in coupling device 200. The segments may cover 120 degrees in smaller hoses and 90 degrees in larger hoses. An outer lay-flat hose has not been shown in this illustration. An opposite end 212, of coupling device 200, may be seen. End 212 has a lumen 210 within and a threaded region 214 lining lumen 210. Threaded region 214 can be used to threadably receive any standard male threaded member for attaching coupling device 200 to any one of many standard hose attachment devices. Outer region 213 may be threaded in some embodiments. Coupling device 200 may thus be attached to any one of a number of external, nonflotation hoses to further transport the fluid from inner lay-flat hose 202.

FIG. 8 illustrates seal or coupling device 140 of FIG. 6. Coupling device 140 may be seen to include first region 142, second region 144, and third region 146, as previously described. Coupling device 140 also includes orifice 154, to be in communication with the annular space between the inner and outer lay-flat hoses. Threaded external orifice 150 may also be seen, which is in communication with internal orifice 154, for inflating and deflating the annular space in between the inner and outer lay-flat hoses. Lumen 148 may be seen for transporting the liquid or solid-liquid mixture through coupling device 140 between the inner lay-flat hose and whatever hose or pipe is secured to third region 146.

FIG. 9 illustrates a hose reel system 220 according to the present invention. Hose reel 220 includes generally opposing spool or end flanges 222 having an outer diameter limit indicated at 224. The hose reel may also have an inner cylindrical member (not visible in FIG. 9) with a position indicated generally at 226. Hose reel 220 may be carried on a portable frame having wheels 228 and a hitch 230. Some hose reels have dividers 234 for separating the various sections of lay-flat hose. Sections of lay-flat hose are visible in FIG. 9 between dividers 234. A hose end coupling device 236 may also be seen in FIG. 9. The hose reels used with the lay-flat hose can be several feet in width, with the hose wound on a 16 inch core, up to a reel maximum diameter of about 88 inches, in some systems.

The inflatable, flotation, lay-flat hose system of the present invention may thus be wound onto hose reel 220, while being substantially emptied of air or other flotation gas. The compact flotation hose may then be transported to another site, unwound from reel 220, inflated, and floated on the surface of a body of liquid that is to be dredged or emptied. The compactness possible with FIG. 9 may be contrasted with the currently used pipe segments in FIGS. 2A through 2C, and 3A and 3B.

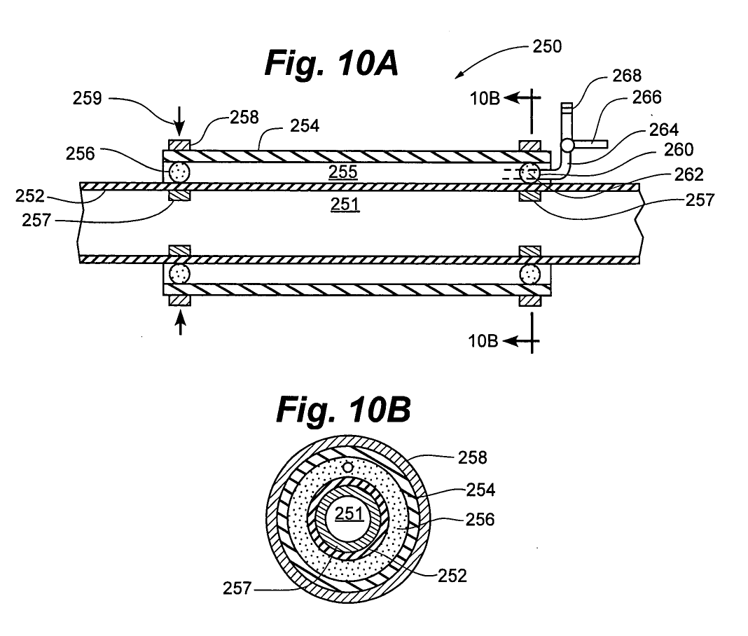

FIG. 10A illustrates an alternate embodiment lay-flat flotation hose system 250. System 250 includes an inner lay-flat hose 252 and an outer lay-flat hose 254, with inner lay-flat hose 252 having a lumen 251 there through. Proceeding from inside to out, an annular ring 257 may be seen for receiving a portion of inner lay-flat hose 252 pressed against ring 257 by a ring seal 256. Ring 256 may be a polymeric or other deformable material ring in some embodiments, and a more rigid, e.g., metallic, ring in other embodiments. Ring 257 can serve to prevent collapse of inner lay-flat hose 252 when ring 256 is brought to bear on inner lay-flat hose 252. Outer lay-flat hose 254 can be urged against ring 256 by an outer hose clamp or segment or other compression ring 258, with pressure brought to bear as indicated at arrows 259. An annular space 255 may be seen, disposed between the inner and outer lay-flat hoses.

Seal 260 has a channel 262 there through for inflating system 250, to fill annular space 255 with inflation gas. Channel 260 can be coupled to a pipe 264 coupled to a ball valve 266 which is further coupled to another pipe segment 268 for coupling to a compressor or other gas source.

FIG. 10B illustrates a cross section taken through FIG. 10A, showing, from inside out, inner lumen 251, ring 257, inner lay-flat hose 252, sealing ring 256, outer lay-flat hose 254, and compression ring or segment 258.

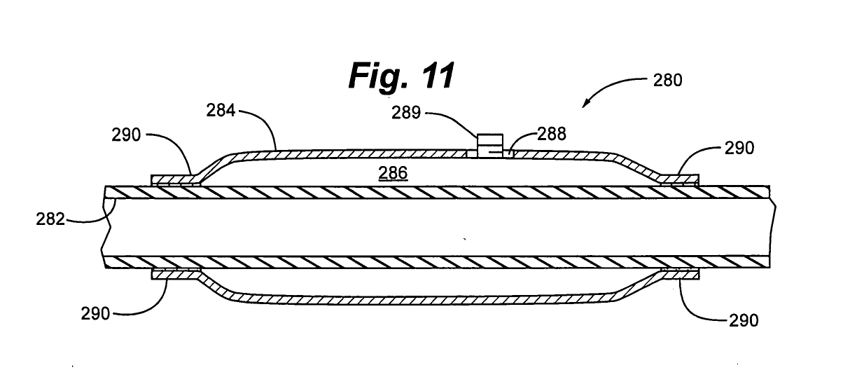

FIG. 11 illustrates another alternate embodiment of the invention in another lay-flat hose system 280. System 280 includes an inner lay-flat hose 282, an outer lay-flat hose 284, and an annular volume 286 therebetween. Annular volume 286 can be filled with inflation gas through a strengthened wall region 288 which can be threaded to receive a threaded plug 289 as in the embodiment illustrated. Inner hose 282 and outer hose 284 can be bonded at regions 290 using numerous adhesives, sealants, solvent welding methods, and other methods for joining two hoses, well known to those skilled in the art. In some methods, the outer hose can be everted at the ends, to bring the outer surface of the outer hose to oppose the outer surface of the inner hose. The hose can be inflated and deflated, as described with respect to the other embodiments.

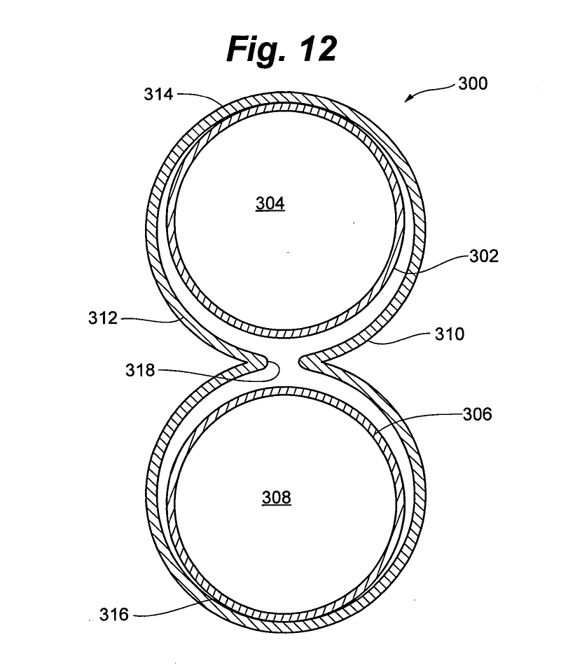

FIG. 12 illustrates another composite lay-flat hose system 300 including a top flotation hose 302 having a channel or lumen 304 and a bottom transfer hose 306 having a channel or lumen 308. Flotation hose 302 is coupled along its length to bottom hose 306 through a hose holder or coupler 312 having an upper portion 314, a bottom portion 316 and a middle portion 318. Hose coupler 312 can serve to bind the transfer hose to the flotation hose along its length. The hose coupler can be formed of a rigid material, a flexible material, or an elastic material. Some hose couplers are closed in the middle between the two hoses. Hose couplers may be dimensioned such that one or both of the two hoses is bound by the hose coupler when the hose attempts to fully expand. In one example, the flotation hose is slightly larger in outer diameter than the inner diameter of the upper portion of the hose coupler, such that travel of the flotation hose with respect to the hose coupler is inhibited when the hose is fully inflated. Some hose couplers are formed from a single rubber or elastomeric loop crossed to form a FIG. 8, with the crossing portion secured upon itself.

Several hose couplers can be disposed along the length of the flotation hose. The flotation hose can be sealed at each end using a sealant or a fitting. Some fittings have a closeable port therein to allow entry of air. Some such systems have a closeable orifice in the flotation hose wall, as previously discussed.

Lay-flat hoses are currently in wide-spread use in manure lagoon pumping operations. The hoses are often fiber reinforced and can be covered with a rubber material, such as polyurethane or nitrile rubber. The wall thickness of some hoses can be from 0.1400 and 0.160 inch thick. The height of an empty lay-flat hose can thus be less than about ⅜ inch, with the double hose height of the present invention being less than about ¾ inch or 1 inch, in various embodiments. A thicker hose may be used in the floatation hose in some embodiments, having a single wall thickness of less than about ¼ inch. The ratio of the outer diameter when full to the height when empty will depend on the outer diameter of the outer hose. A composite, double hose may have an outer diameter of 10 inches when full compared to a height of less than about ¾ inch when empty. The ratio of outer diameter of outer hose when full to height when empty is at least about 5 or 10, depending on the embodiment.

Lay-flat hoses used in the present invention are available from several source. Lay-flat hose may be obtained from Tipsa (Spain), Angus (England), Petzetakis (Greece), and Gollmer & Hummel (Germany). Hoses used may have a pressure rating of between 50 to 250 PSI working pressure, having a three-fold safety factor or burst factor in the United States and a two and one-half times safety factor in Europe. This means that a 200 PSI working pressure hose has a 600 plus PSI burst rating. Normally, these lay-flat hoses will have between a 50 and 300 PSI working pressure rating. Some lay-flat hoses used to form the composite flotation hoses of the present invention have a working pressure of at least 100 or 200 PSIG, and a burst pressure of at least 300 or 600 psig.

The portion of the coupling coupled to a single walled hose can have a variety of fittings, for example, Camlok or Victolic fittings. These fittings can couple the double walled floatation hose to a single walled lay-flat hose that may include one or two 660 foot lengths. The lay-flat hose can ultimately be dragged behind a tractor or spreader, coupled to the tractor with a “Jag swivel”, see U.S. Pat. No. 6,116,275.

The present invention has been described with respect to the various examples previously discussed. The scope of the invention, however, is not limited by these illustrative examples. The scope of the invention is defined by the claims that follow.

1. A flotation hose comprising:
a first lay-flat hose having a first region and a second region longitudinally displaced from the first region;
a second lay-flat hose disposed within the first lay-flat hose and having a first region and a second region displaced longitudinally from the first region;
a first seal for sealing the first lay-flat hose first region to the second lay-flat hose first region; and
a second seal for sealing the first lay-flat hose second region to the second hose second region, such that a sealed annular volume can be formed between the first lay-flat hose and the second lay-flat hose.

2. The flotation hose of claim 1, in which the first and second seals are formed of a rigid material and have the first and second hoses held to the seals with compression rings.

3. The flotation hose of claim 1, further comprising a valve providing closable external gaseous access to the annular volume.

4. The flotation hose of claim 3, in which the valve is disposed in at least one of the first and second seals.

5. The flotation hose of claim 1, in which the seal is formed of material selected from the group consisting of metals, polymers, ceramics, sealants and combinations thereof.

6. The flotation hose of claim 1, in which the first lay-flat hose has a first outside diameter when fully pressurized that is at least about 10 times the height of the first lay-flat hose when empty and not pressurized.

7. The flotation hose of claim 1, in which the first and second lay-flat hose are fiber reinforced.

8. The flotation hose of claim 1, in which the first lay-flat hose has an outside diameter of at least about 4 inches when the annular volume is inflated.

9. The flotation hose of claim 1, in which the first and second hoses each have a length of at least about 100 feet.

10. A flotation hose for use in an external environment, the hose comprising:
a first lay-flat hose having a length, an internal lumen, two sealed end regions, and a closeable orifice in communication between the internal lumen and the external environment; and
a second lay-flat hose coupled along the length of the first lay-flat hose to the first lay-flat hose.

11. The flotation hose of claim 10, in which the second hose is disposed within the first hose and the first hose sealed end regions are sealed about the second hose.

12. The flotation hose of claim 10, in which the first hose two sealed end regions include rigid fittings.

13. A system for conveying fluids, the system comprising:
a flotation hose including a first lay-flat hose having a length, an internal lumen, two sealed end regions, and a closeable orifice in communication between the internal lumen and the external environment, and a second lay-flat hose coupled along the length of the first lay-flat hose to the first lay-flat hose; and
a hose reel having the first and second lay-flat hoses wound thereabout.

14. The system of claim 13, in which the second hose is disposed within the first hose and the first hose sealed end regions are sealed about the second hose.

15. The system of claim 13, in which at least one of the seals has a closeable orifice in the seal for allowing entry and exit of a gas.

16. The system of claim 13, in which the first lay-flat hose has a first outside diameter when fully pressurized that is at least about 10 times the height of the first lay-flat hose when the space is empty and not pressurized.

17. A method for making a flotation hose, the method comprising:
disposing a second lay-flat hose inside a first lay-flat hose; and
coupling the first and second lay-flat hoses together at a first end and coupling the first and second lay-flat hoses together at a second end to form a space between the first and second hoses,
in which the space can be filled with a gas to form an annular volume between the first and second hoses.

18. The method of claim 17, further comprising filling the space with the gas to form the annular volume between the first and second hoses.

19. The method of claim 17, in which the first and second hose coupling includes coupling using a device including an orifice providing gas access to the space between the first and second hoses from outside of the first hose.

20. A method for removing water and solids from a body containing water and solids to at least an edge of the body, the method comprising:
unrolling a composite hose from a reel, wherein the composite hose includes a first lay-flat hose having a length, an internal lumen, two sealed end regions, and a closeable orifice in communication between the internal lumen and the external environment, and a second lay-flat hose coupled along the length of the first lay-flat hose to the first lay-flat hose.;
introducing a gas into the first hose internal lumen;
coupling one end of the second hose to a movable solid-liquid mixing device; and
extending the composite hose between the movable solid-liquid mixing device and the edge of the body, such that the composite hose having the gas within floats on the body.

21. The method of claim 20, further comprising pumping the solid-liquid mixture from the moveable device to the edge.

22. The method of claim 21, in which the body includes manure and in which the pumping includes pumping a manure water mixture.

23. The method of claim 21, in which the body includes fresh water and sediment, and in which the pumping includes pumping a fresh water-sediment mixture.

24. The method of claim 21, in which the body includes salt water and sediment, and in which the pumping includes pumping a salt water-sediment mixture.

25. The method of claim 21, in which the body includes brackish water and sediment, and in which the pumping includes pumping a brackish water-sediment mixture.

26. The method of claim 21, in which the body includes industrial sludge, and in which the pumping includes pumping the industrial sludge.

27. The method of claim 21, in which the body includes wastewater treatment sludge, and in which the pumping includes pumping the wastewater treatment sludge.

28. The method of claim 20, in which the second hose is disposed within the first hose to form the internal lumen therebetween, the first hose sealed end regions are sealed about the second hose, and in which the flotation gas in introduced into the internal lumen formed in between the first and second hoses

29. A device for creating a flotation hose from coupling a first lay-flat hose over a second lay-flat hose that has a smaller outside diameter than the first lay-flat hose, the device comprising:
a body having a first region for coupling to the first hose, a second region for coupling to the second hose, a third region for receiving or discharging a fluid, and a lumen therethrough;
in which the second region has an outside diameter about equal to the inside diameter of the second hose,
in which the first region has an outside region about equal to the inside diameter of the first hose,
such that the first hose can be coupled to the first region with a first compression ring and the second hose can be coupled to the second region with a second compression ring.

30. The device of claim 29, in which the second region is disposed longitudinally between the first and third regions.

31. The device of claim 29, in which the third region is disposed longitudinally between the third and second regions.

32. The device of claim 29, in which the second region has an outer diameter of at least about 3 inches and in which the first region has an outer diameter of at least about 4 inches.

33. The device of claim 29, in which the first region includes at least one external grove for receiving a portion of the first hose driven inward by a compression member.

34. The device of claim 29, in which the second region in includes at least one external grove for receiving a portion of the second hose driven inward by a compression member.

35. The device of claim 29, further comprising an orifice through the body to provide external gas access to a space between the first and second hoses.
